(19) United States
(12) Patent Application Publication
(10) Pub. No.: US 2024/0419159 A1
(43) Pub. Date: Dec. 19, 2024

(54) METHOD OF GENERATING AN ANOMALIES DETECTION MODEL AND METHOD OF DETECTING ANOMALIES USING SUCH MODEL

(71) Applicant: STMicroelectronics International N.V., Geneva (CH)

(72) Inventor: Mohamed Ali Moussa, Toulon (FR)

(21) Appl. No.: 18/665,744

(22) Filed: May 16, 2024

(30) Foreign Application Priority Data
Jun. 15, 2023 (FR) 2306122

(51) Int. Cl. G05B 23/02

(52) U.S. Cl. CPC G05B 23/0235; G05B 23/024; G05B 23/027

(57) ABSTRACT

According to one aspect, a computer-implemented method can be used for producing an anomaly detection model. The method includes obtaining a learning data stream from a physical system, incrementally computing principal components of the learning data stream, performing orthonormalization of the principal components computed so as to obtain an orthonormal base representing the learning data stream, and producing the anomaly detection model including the orthonormal base and a detection threshold defined by a user. The anomaly detection model can then be applied to a physical system.

### CROSS-REFERENCE TO RELATED APPLICATIONS

This application claims priority to French Application No. 2306122, filed on Jun. 15, 2023, which application is hereby incorporated herein by reference.

### TECHNICAL FIELD

Subject matter disclosed herein relates to a method of generating an anomalies detection model and method of detecting anomalies using such model.

### BACKGROUND

Anomaly detection (or “outlier detection”) in a physical system is a technique used for identifying data that significantly differ from data representing normal behavior of the physical system. These data are often referred to as “anomalies” or “aberrant values.”

Anomaly detection finds an interest in many applications. Some applications use a microcontroller deployed in the physical system to be monitored. Such a microcontroller is then configured to implement anomaly detection.

Anomaly detection implemented by a microcontroller makes it possible to monitor in real time to detect abnormal behaviors in a physical system using data acquired by at least one sensor in this system. This technique can be used in a variety of fields such as automobile, aerospace, energy, manufacturing production, health monitoring and many others.

In the context of anomaly detection, a microcontroller generally uses a model that represents the normal behavior of a system to analyze data collected by at least one sensor in the system.

In particular, the model is used to compare the current data collected by the sensor(s) with those of the normal behavior. If the current data differ too much from the expected ones, this may indicate an anomaly or a malfunctioning in the system. In this case, an alert can be triggered to warn an operator of the system.

The anomaly detection implemented therefore makes it possible to warn of breakdowns and failures of the system. This makes it possible to improve the reliability and safety of the system.

The model used for detecting anomalies can be obtained using a machine learning algorithm.

In particular, the machine learning algorithm is configured to generate a model for anomaly detection using learning data representing a normal behavior of the system. The anomaly detection model is produced so as to define limits of the normal behavior of the system. The anomaly detection model can then be used by a microcontroller deployed in the physical system to be monitored.

In some applications, it may be difficult to obtain learning data before the solution is deployed in the system to be monitored. It is then preferable to implement the learning, i.e., the production of the anomaly detection model, actually within the physical system to be monitored. For example, the learning of the anomaly detection model is then implemented by a microcontroller deployed in the system to be monitored. Once the anomaly detection model has been produced, this same microcontroller is then configured to use this anomaly detection model.

In this case, the learning is implemented by the microcontroller during a period defined by the user from learning data acquired by at least one sensor.

In order to produce an anomaly detection model from a data stream using a memory with restricted capacity, the anomaly detection model can be produced incrementally. In other words, the anomaly detection model is produced along with the acquisition of a stream of learning data. An imprint of each learning data item is stored in the memory once these learning data have been used for producing the anomaly detection model. This imprint can correspond to information extracted from the learning data acquired or can correspond to the learning data itself.

There are several solutions for producing an anomaly detection model that is capable of implementing incremental anomaly detection.

It is for example possible to produce such an anomaly detection model using a Gaussian mixture model or a method based on a Z-score or standard score.

However, these methods are not sufficiently effective in some applications. Furthermore, they may take up a great deal of space in the memory and require complex computations to be executed.

### SUMMARY

Embodiments can provide solution for obtaining a model for anomaly detection that is simple to implement by a microcontroller.

According to one aspect, a method implemented by computer for producing an anomaly detection model is proposed. The method comprises obtaining a learning data stream, incrementally computing principal components of the learning data stream, performing orthonormalization of the principal components computed so as to obtain an orthonormal base representing the learning data stream, and producing an anomaly detection model including the orthonormal base and a detection threshold defined by the user.

For example, the method for producing the anomaly detection method corresponds to a learning phase for producing the detection model. The duration of this learning phase can be defined by the user.

Such a method makes it possible to obtain an anomaly detection method adapted for implementing incremental anomaly detection. In particular, the detection model is adapted for classifying data that it receives as an input as being normal data or as being abnormal data. These data may come from an acquisition made in a physical system to be monitored. For example, the data may be data measured by an accelerometer in a rotary machine. The data may also correspond to an electric current consumed by an apparatus, or to an audible signal associated with a given event.

The method makes it possible to simply define an orthonormal base corresponding to a normal behavior of the physical system. The anomaly detection model comprises the orthonormal base and the detection threshold defined. The anomaly detection model is therefore simple, occupies relatively little space in memory and can be implemented rapidly. In this way, such a detection model can be produced and implemented by a microcontroller.

In an advantageous embodiment, the incremental computing of the principal components of the data stream comprises a use of a method for analyzing covariance-free incremental principal components.

Such a method makes it possible to obtain the principal components of the learning data stream without requiring computing a covariance matrix of the data stream. Such a method thus makes it possible to reduce the memory occupation for obtaining the principal components of the learning data stream and is quicker to implement.

Preferably, the orthonormalization of the base comprises use of a modified Gram-Schmidt algorithm using the principal components of the learning data stream.

Advantageously, the method further comprises production of a computer program product for detecting anomalies comprising instructions which, when the program is executed by a computer, cause the latter to implement the detection model.

In an advantageous embodiment, the detection threshold is higher than or equal to 70%, for example of the order of 90%. The detection threshold represents a percentage of energy captured by the calculated base.

According to another aspect, a method implemented by computer for anomaly detection comprises obtaining a data stream to be monitored, vectorial projection of the data to be monitored onto an orthonormal base representing a learning data stream supplied by an anomaly detection model, computing energy of the data projected onto the orthonormal base and computing energy of the data to be monitored, computing an energy ratio between the computed energy of the data to be monitored and the computed energy of the data projected onto the orthonormal base, comparing the computed ratio with a detection threshold supplied by the anomaly detection model, and evaluating the data to be monitored as being normal data or abnormal data according to a result of the comparison.

For example, the anomaly detection method corresponds to an inference phase for using the detection model produced.

Such an anomaly detection method has an advantage of using a simple detection model occupying little space in memory. The anomaly detection method also has an advantage of requiring few computing resources. The anomaly detection method can therefore be implemented quickly. Such an anomaly detection method can therefore be implemented by a microcontroller.

Preferably, the data are evaluated as being normal when the ratio is higher than or equal to the detection threshold and as being abnormal when the ratio is lower than the detection threshold.

Advantageously, the method further comprises generating an alert signal if the data to be monitored are evaluated as being abnormal in order to notify an anomaly detection.

According to another aspect, a method implemented by computer comprises use of a method for producing an anomaly detection method as described previously, then use of an anomaly detection method as described previously.

Thus, the method for producing the anomaly detection model (learning phase) is followed by the detection method (inference phase). These two methods are then implemented successively by a microcontroller deployed in a physical system to be monitored for example.

According to another aspect, a computer program product for producing an anomaly detection model is provided, comprising instructions which, when the program is executed by a computer, cause the latter to implement a method for producing an anomaly detection model as described before.

According to another aspect, a computer program product for detecting anomalies is provided, comprising instructions which, when the program is executed by a computer, cause the latter to implement an anomaly detection method as described before.

According to one aspect, a microcontroller comprises a memory comprising a computer program product for producing an anomaly detection model as described before and a processing unit configured to execute the computer program product.

Advantageously, the memory further comprises a computer program product for detecting anomalies as described before, the processing unit also being configured to execute this computer program product.

### BRIEF DESCRIPTION OF THE DRAWINGS

Other advantages and features of the invention will become apparent upon examining the detailed description of in no way limitative embodiments, and from the appended drawings wherein:

FIG. 1 illustrates a microcontroller MCU configured to implement an anomaly detection method;

FIG. 2 illustrates a method implemented by computer for anomaly detection;

FIG. 3 illustrates a method implemented by computer for producing an anomaly detection model;

FIG. 4 illustrates a method implemented by computer for anomaly detection in a physical system to be monitored; and

FIG. 5 illustrates a system that can utilize an anomaly detection model.

### DETAILED DESCRIPTION OF ILLUSTRATIVE EMBODIMENTS

FIG. 1 illustrates a microcontroller MCU configured to implement an anomaly detection method.

The microcontroller MCU can be integrated in a system for which monitoring of operating anomalies is required. The microcontroller MCU can be configured to receive data acquired by an acquisition device of the system. These acquired data then represent the operation of the system. For example, the physical system may be a rotary machine. In this case, the data may be data measured by an accelerometer in a rotary machine.

The microcontroller MCU comprises a processing unit UT and a memory MEM.

The memory MEM comprises a computer program PRG1 comprising instructions which, when they are implemented by the processing unit UT of the microcontroller, cause the latter to implement a method for producing an anomaly detection model as described hereinafter. This method makes it possible to obtain an anomaly detection model MDL from learning data. More particularly, this method makes it possible to generate a computer program PRG2 comprising instructions which, when they are implemented by the processing unit UT of the microcontroller, cause the latter to implement an anomaly detection method as described hereinafter using the anomaly detection model MDL produced.

Once the computer program has been produced, the memory MEM comprises this computer program PRG2 using the anomaly detection model MDL produced.

This computer program PRG2 can be executed by the processing unit UT to implement a detection of anomalies from data to be monitored.

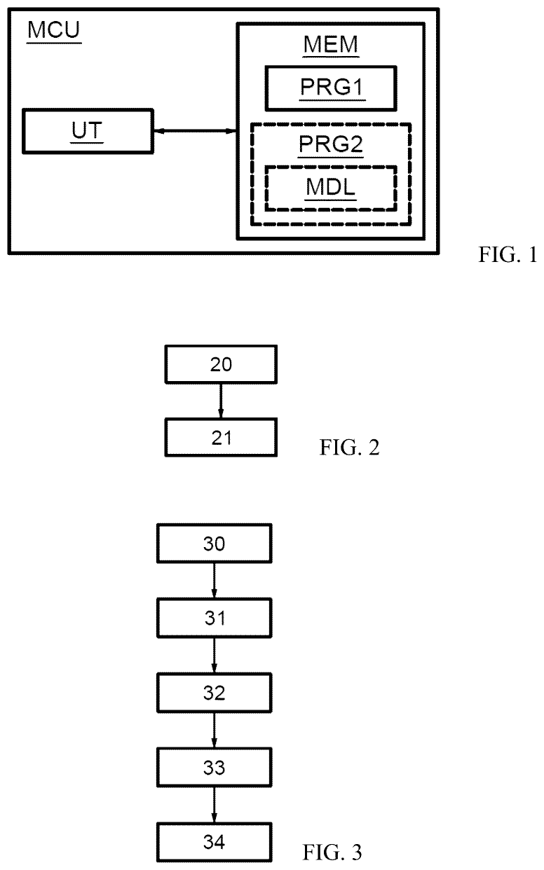

FIG. 2 illustrates a method implemented by computer for anomaly detection. This method can be implemented by a microcontroller MCU as described in relation to FIG. 1.

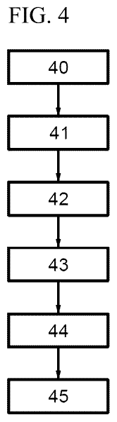

The method comprises implementation 20 of a method for producing an anomaly detection method and then implementation 21 of an anomaly detection method using the anomaly detection model produced. The method for producing an anomaly detection method is described hereinafter in relation to FIG. 3. The anomaly detection method is described hereinafter in relation to FIG. 4.

FIG. 3 illustrates a method implemented by computer for producing an anomaly detection model. The computer may be the microcontroller MCU.

Such a method is used for defining a model determining limits of normal behavior of a physical system. The method for producing the anomaly detection model therefore corresponds to a learning phase for producing the detection model. In particular, the learning phase makes it possible to adjust parameters of the detection model along with the acquisition of a data stream representing the behavior of the physical system to be monitored. The duration of this learning phase can be defined by the user. The duration of the learning phase makes it possible to define the quantity of learning data to be used for producing the detection model.

The method comprises a step 30 of obtaining a learning data stream. In this step 30, the learning data stream is supplied to the microcontroller. The learning data are in particular acquired by an acquisition device, such as a sensor.

The learning data are data representing normal behavior of a system. Each learning data item is represented by a vector of values.

The method then comprises a step 31 of incremental computation of the principal components of the data stream. In particular, the processing unit of the microcontroller implements a method of analyzing covariance-free incremental principal components. Such an analysis method is well known to a person skilled in the art. In particular, the analysis method corresponds to an incremental algorithm for approximating the principal components using a data stream. The number of principal components is fixed in advance. The algorithm applies an updating of the principal components at each data acquisition. This updating is implemented on the basis of various projection operations.

The method is implemented incrementally, i.e., the learning data are used as they are acquired.

This analysis method makes it possible to obtain a set of vectors of the principal components of the data stream.

This analysis method has an advantage of avoiding computing a covariance matrix. This method therefore makes it possible to extract the principal components of a set of data iteratively and using fewer resources (computing operations and memory) than the traditional methods based on covariance.

The method then comprises a step 32 of orthonormalization of the set of vectors of the principal components of the data stream. The orthonormalization corresponds to a transformation of this set of vectors into an orthonormal base. In particular, the processing unit executes a modified Gram-Schmidt algorithm well known to persons skilled in the art.

In particular, for a set of vectors of principal components consisting of vector xj, j ranging from 1 to n, n corresponding to the number of vectors xj, the algorithm comprises an initialization of vectors vj, j ranging from 1 to n. Each vector vj is initialized to the value of the vector xj. Next, the algorithm comprises a loop for computing orthonormal vectors qj, j ranging from 1 to n. The loop for computing orthonormal vectors qj comprises a computation of the vector qj. The computation of the vector qj corresponds to a normalization of the vector vj. The vector qj is therefore equal to the division of the vector vj by its Euclidean norm (qj=vj/∥vj∥₂). The loop for computing the vector qj next comprises a loop for updating the vectors vk, k being an index ranging from j+1 to n. The loop for updating the vectors vk comprises a computation of the vector vk by the following formula:

$${v}_{k} = {v}_{k} - ( {q}_{j}^{T} {v}_{k} ) {q}_{j}$$

The orthonormalization step 32 makes it possible to obtain an orthonormal basis of vectors qj that corresponds to an orthogonalized set of the initial vectors xj. The orthonormal base serves to correct any orthogonality error caused by the approximation of the principal components calculated. The orthonormal base also serves to compute the energy of the data carried by this base.

The method comprises a production 33 of an anomaly detection model including the orthonormal base and a detection threshold defined by the user. The detection threshold may be higher than or equal to 70%, for example of the order of 90%.

Advantageously, the method further comprises production 34 of a computer program product comprising instructions which, when the program is executed by a computer, cause the latter to implement the detection model.

Such a method makes it possible to obtain an anomaly detection model adapted for implementing incremental anomaly detection. In particular, the detection model is adapted for classifying data that it receives as an input as being normal data or abnormal data.

The method makes it possible to simply define an orthonormal base corresponding to a normal behavior of the physical system. The anomaly detection model comprises the orthonormal base and the detection threshold defined. The anomaly detection model is therefore simple, occupies relatively little space in memory and can be implemented rapidly. In this way, such a detection model can be produced and implemented by a microcontroller.

FIG. 4 illustrates a method implemented by computer for anomaly detection in a physical system to be monitored.

The method comprises a step 40 of obtaining a data stream to be monitored. In this step 40, the data stream to be monitored is supplied to the microcontroller. The data to be monitored are in particular acquired by an acquisition device disposed in the physical system to be monitored. Each data item is represented by a vector of values.

The method then comprises a vectorial projection step 41. In this step 41, the processing unit projects the data to be monitored onto the orthonormal base. The vectorial projection corresponds to a scalar product between the data to be monitored and each vector of the orthonormal base.

The method then comprises an energy-computing step 42. In this step 42, the processing unit computes the energy of the data projected onto the orthonormal base. The processing unit also computes the energy of the data to be monitored. The energy of a vector corresponds to the sum of the squares of all the elements of this sector.

The method then comprises an energy ratio computing step 43. In this step 43, the processing unit computes a ratio between the energy of the data to be monitored and the energy of the data projected onto the orthonormal base.

The method then comprises a comparison step 44. In this step, the processing unit compares the computed ratio with the detection threshold supplied by the detection model. This comparison makes it possible to determine whether the data to be monitored correspond to normal data, such as those used for training the detection model, or to data that correspond to abnormal data.

In particular, the method comprises an evaluation step 45. In this step, the processing unit evaluates the data to be monitored according to the result of the comparison.

More particularly, if the ratio computed is higher than or equal to the detection threshold, then the processing unit evaluates the data to be monitored as being normal data.

If the ratio computed is lower than the detection threshold, then the processing unit evaluates the data to be monitored as being abnormal data.

If the processing unit evaluates the data to be monitored as being abnormal data, then the method can comprise an alert step. In this step, the processing unit generates an alert signal for notifying a detection of anomalies.

Such an anomaly detection method has an advantage of using a simple detection model occupying little space in memory. The anomaly detection method also has an advantage of requiring few computing resources. The anomaly detection method can therefore be implemented quickly. Such an anomaly detection method can therefore be implemented by a microcontroller deployed in a physical system to be monitored.

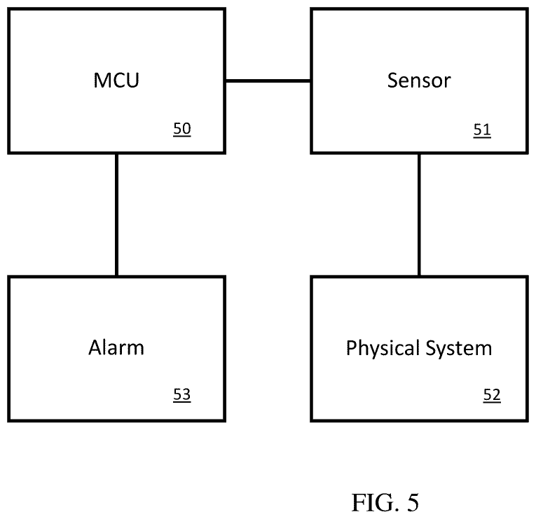

FIG. 5 illustrates a system that can utilize the methods disclosed herein. The system of FIG. 5 includes a microcontroller 50, such as the one described with respect to FIG. 1. The microcontroller 50 can be used to perform anomaly detection to monitor in real time a physical system 52 using data acquired by at least one sensor 51. The anomaly detection can be used to compare current data collected by the sensor(s) 51 with those of the normal behavior. If the current data differ too much from the expected ones, this may indicate an anomaly or a malfunctioning in the system. In this case, an alert can be triggered to alarm 53 to warn an operator of the system thereby making it possible to warn of breakdowns and failures of the system.

This technique can be used in a variety of fields such as automobile, aerospace, energy, manufacturing production, health monitoring and many others. For example, the data may be data measured by an accelerometer in a rotary machine. The data may also correspond to an electric current consumed by an apparatus, or to an audible signal associated with a given event.

What is claimed is:

1. A computer-implemented method for producing an anomaly detection model, the method comprising:
obtaining a learning data stream from a physical system;
incrementally computing principal components of the learning data stream;
performing orthonormalization of the principal components computed so as to obtain an orthonormal base representing the learning data stream; and
producing the anomaly detection model including the orthonormal base and a detection threshold defined by a user.

2. The method according to claim 1, wherein obtaining the learning data stream comprises using a sensor to monitor the physical system.

3. The method according to claim 1, wherein the incremental computing of the principal components of the data stream comprises using a method for analyzing covariance-free incremental principal components.

4. The method according to claim 1, wherein the orthonormalization comprises using a modified Gram-Schmidt algorithm using the principal components of the learning data stream.

5. The method according to claim 1, further comprising generating a computer program product for detecting anomalies comprising instructions which, when the computer program is executed by a computer, cause the computer to implement the anomaly detection model.

6. The method according to claim 5, further comprising executing the computer program to perform real time anomaly detection of a real-world physical system.

7. The method according to claim 1, wherein the detection threshold is greater than or equal to 70%.

8. A non-transitory computer-readable storage medium storing a computer program product for implementing the method according claim 1.

9. A computer-implemented method for detecting anomalies, the method comprising:
obtaining a stream of data to be monitored from a sensor monitoring a physical system;
performing a vectorial projection of the data to be monitored onto an orthonormal base representing a learning data stream supplied by an anomaly detection model;
computing energy of the data projected onto the orthonormal base;
computing energy of the data to be monitored;
computing an energy ratio between the computed energy of the data to be monitored and the computed energy of the data projected onto the orthonormal base;
comparing the computed ratio with a detection threshold supplied by the anomaly detection model;
evaluating the data to be monitored as being normal data or abnormal data according to a result of the comparing; and
in response to evaluating the data as abnormal data, generating a notification indicating an anomaly within the physical system.

10. The method according to claim 9, wherein the sensor comprises an accelerometer and the physical system comprises rotary machine.

11. The method according to claim 9, wherein the physical system comprises an electrical apparatus and the data to be monitored provides information related to an electric current consumed by the apparatus.

12. The method according to claim 9, wherein evaluating the data comprises evaluating the data as being normal when the ratio is greater than or equal to the detection threshold and as being abnormal when the ratio is lower than the detection threshold.

13. The method according to claim 9, wherein evaluating the data comprises evaluating the data as being abnormal further, the method further comprising generating an alert signal in order to notify detection of an anomaly.

14. The method of claim 9, further comprising producing the anomaly detection model.

15. The method of claim 14, wherein producing the anomaly detection model comprises:
obtaining the learning data stream;
incrementally computing principal components of the learning data stream;
performing orthonormalization of the principal components computed so as to obtain the orthonormal base representing the learning data stream; and
producing the anomaly detection model including the orthonormal base and the detection threshold defined by a user.

16. A non-transitory computer-readable storage medium storing a computer program product for implementing the method according claim 9.

17. A microcontroller comprising:
a processing unit; and
a non-transitory memory coupled to the processing unit and storing a computer program that includes instructions that, when executed by the processing unit, cause the processing unit to:
obtain a stream of data to be monitored;
perform a vectorial projection of the data to be monitored onto an orthonormal base representing a learning data stream supplied by an anomaly detection model;
compute energy of the data projected onto the orthonormal base;
compute energy of the data to be monitored;
compute an energy ratio between the computed energy of the data to be monitored and the computed energy of the data projected onto the orthonormal base;
perform a comparison of the computed ratio with a detection threshold supplied by the anomaly detection model; and
evaluate the data to be monitored as being normal data or abnormal data according to a result of the comparison.

18. A system comprising:
the microcontroller according to claim 17;
a physical system; and
a sensor coupled to the physical system and the microcontroller.

19. The system according to claim 18, further comprising an alarm coupled to the microcontroller.

20. The system according to claim 18, wherein the sensor comprises an accelerometer and the physical system comprises rotary machine.

21. The system according to claim 18, wherein the physical system comprises an electrical apparatus and the sensor comprises a current sensor.
